(19) United States
(12) Patent Application Publication
(10) Pub. No.: US 2006/0217016 A1
(43) Pub. Date: Sep. 28, 2006

(54) Silicone/polyurethane coated fabrics

(76) Inventors: Shaow Lin, Midland, MI (US); Toshio Suzuki, Midland, MI (US); Simon Toth, Midland, MI (US)

Correspondence Address: Alan Zombeck;Dow Corning Corporation, 2200 W Salzburg Road, Midland, MI, 48686-0994, US

(21) Appl. No.: 10/555,116

(22) PCT Filed: Jun. 1, 2004
(86) PCT No.: PCT/US04/17277

§ 371 Date: Nov. 1, 2005

Related U.S. Application Data
(60) Provisional application No. 60/475,741, filed on Jun. 4, 2003.

(51) Int. Cl. B32B 5/02; B32B 15/00; B32B 27/02

(52) U.S. Cl. 442/59; 442/168; 428/164

(57) ABSTRACT

Fabrics are disclosed having a coating comprising a reaction product of a silicone component derived from an aqueous silicone emulsion and a polyurethane component derived from an aqueous silicone dispersion. The fabrics are particularly useful in the preparation of airbags having improved air or gas retention properties.

The present invention provides fabrics having a coating resulting from the reaction product of a silicone component and a polyurethane component. More particularly, the fabrics of the present invention are coated with a coating composition comprising a reaction product of a silicone component derived from an aqueous silicone emulsion and a polyurethane component derived from an aqueous polyurethane dispersion. The coated fabrics of the present invention are particularly useful in the construction of airbags for automotive applications.

Typically airbag fabrics are coated with a silicone composition to provide airbags with the necessary thermal barrier from high temperature burst associated with hot gas ignition on deployment and some air/gas retention for a very short duration afterward. With the advancement of safer cold air canister and hybrid air/gas sources, a high thermal barrier property of an airbag coating is no longer a requirement. Instead, next generation side airbags and inflatable curtains (i.e. side air bags) need to retain pressurized air/gas to meet the initial burst pressure of the bag and stay inflated long enough to provide rollover protection for greater than 5 seconds. As silicone coating is known to be highly permeable to air and gas, it is no longer an ideal coating material for next generation side airbags and inflatable curtains. There exists a need for a high air/gas retention coating that coats and adheres well to the airbag fabrics.

One technique that has been reported to decrease coating weights and maintain low permeability performance of coated fabrics for use in airbags has been to use a two layered coating system, as disclosed for example in U.S. Pat. No. 6,177,365. The '365 patent teaches the application of a first layer to the fabric of a non-silicone material followed by the application of a silicone containing topcoat. U.S. Pat. No. 6,177,366 also teaches a two layer coating system for airbag fabrics where the first layer contains up to 30% of a silicone resin and the topcoat contains a silicone material. U.S. Pat. No. 6,239,046 teaches airbags having a first coating layer of adhesive polyurethane and a second coating layer of an elastomeric polysiloxane.

Alternative coating compositions have been disclosed based on polyurethanes, such as in U.S. Pat. No. 5,110,666, or on polyurethane/polyacrylate dispersions as found in U.S. Pat. No. 6,169,043. In co-pending U.S. patent application Ser. Nos. 10/118870, 10/118,746, and 10/321,234, we disclose curable coating compositions from emulsions of elastomeric polymers and polyurethane dispersions and methods for coating fabrics, including air bags.

U.S. Pat. No. 6,077,611 discloses printable paper release compositions from the combination of an aqueous silicone emulsion with an aqueous polyurethane emulsion. However, the '611 patent does not teach the use on its compositions for coating air bag fabrics.

While the coating systems cited above represents advancements in airbag technology, a need still exists to provide improved compositions and techniques for coating fabrics for use in airbags. In particular, coating compositions that provide similar or improved permeability at lower coating weights and improved aging stability are desired. Such coated fabrics are also expected to have further utility in any application requiring a fabric with reduced gas permeability.

The present invention provides a coated fabric comprising a fabric having a coating composition on at least a portion of the surface of the fabric, wherein the coating composition comprises a reaction product of;
A) 5 to 60 weight parts of a silicone component wherein the silicone component is derived from an aqueous silicone emulsion, and
B) 40 to 95 weight parts of a polyurethane component wherein the polyurethane component is derived from an aqueous polyurethane dispersion.

The present invention further provides a method of coating a fabric comprising;

(I) applying a composition on one surface of the fabric, the composition comprising;

A) 5 to 60 weight parts of a silicone component wherein the silicone component is derived from an aqueous silicone emulsion, and
B) 40 to 95 weight parts of a polyurethane component wherein the polyurethane component is derived from an aqueous polyurethane dispersion, and
   (II) exposing the layer to air for sufficient time to form a cured coating. The present invention also relates to the fabrics prepared by this method.

The coated fabrics of the present invention are suitable for the construction of automotive airbag articles with improved air/gas retention properties.

The silicone component suitable as component A) in the present invention is derived from an aqueous silicone emulsion. Typically, the aqueous silicone emulsion is a water continuous emulsion of an organopolysiloxane. Aqueous silicone emulsions are well known in the art and are commonly produced by dispersing an organopolysiloxane in water with various emulsifying agents. The various emulsifying agents that can be used to create the silicone emulsions include anionic, nonionic, cationic, and zwitterionic surfactants, as well as polyvinyl alcohols. The aqueous silicone emulsion can be either a curable silicone emulsion, or an emulsion of pre-cured silicone.

In the curable silicone emulsion embodiment, the curable silicone emulsion comprises;

a) a curable organopolysiloxane,

b) an optional crosslinking agent,

c) a cure agent in an amount sufficient to cure the organopolysiloxane.

The curable organopolysiloxane a) is defined herein as any organopolysiloxane having at least two curable groups present in its molecule. As used herein, a curable group is defined as any hydrocarbon group that is capable of reacting with itself, or alternatively with a crosslinker to crosslink the organopolysiloxane. This crosslinking results in a cured organopolysiloxane. Representative of the types of curable organopolysiloxanes that can be used as components in the silicone emulsions of the present invention are those known in the art to produce silicone rubbers or elastomers upon curing. Typically, these organopolysiloxanes can be cured via a number of crosslinking mechanisms employing a variety of cure groups on the organopolysiloxane, cure agents, and optional crosslinking agent. Two of the more common crosslinking mechanisms used in the art to prepare cured silicone films from silicone emulsions are addition cure and condensation cure. Thus, components (a), (b), and (c) can be selected according to the choice of cure or crosslinking mechanisms for the organopolysiloxane.

In one embodiment of the present invention, the curable silicone emulsion comprises an organopolysiloxane that is addition curable. In this embodiment, the silicone emulsion comprises a curable organopolysiloxane containing at least two alkenyl groups, an organohydrido silicon compound is used as a crosslinking agent, and a hydrosilylation catalyst is used as the cure agent. Thus, in the addition curable emulsion embodiment, the silicone emulsion comprises;

(a′) a curable organopolysiloxane containing at least two alkenyl groups,

(b′) an organohydrido silicon compound,

(c′) a hydrosilylation catalyst.

Component (a′) is selected from a curable organopolysiloxane which contains at least 2 alkenyl groups having 2 to 20 carbon atoms in its molecule. The alkenyl group on the curable organopolysiloxane is specifically exemplified by vinyl, allyl, butenyl, pentenyl, hexenyl and decenyl, preferably vinyl or hexenyl. The position of the alkenyl functionality is not critical and it may be bonded at the molecular chain terminals, in non-terminal positions on the molecular chain or at both positions. The remaining (i.e., non-alkenyl) silicon-bonded organic groups of the curable organopolysiloxane are independently selected from hydrocarbon or halogenated hydrocarbon groups which contain no aliphatic unsaturation. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenylethyl; and halogenated alkyl groups having 1 to 20 carbon atoms, such as 3,3,3-trifluoropropyl and chloromethyl. Typically, the non-alkenyl silicon-bonded organic groups in the curable organopolysiloxane makes up at least 85, or alternatively at least 90 mole percent, of the organic groups in the curable organopolysiloxane.

Thus, curable organopolysiloxane (a′) can be a homopolymer, a copolymer or a terpolymer containing such organic groups. Examples include copolymers comprising dimethylsiloxy units and phenylmethylsiloxy units, copolymers comprising dimethylsiloxy units and 3,3,3-trifluoropropylmethylsiloxy units, copolymers of dimethylsiloxy units and diphenylsiloxy units and interpolymers of dimethylsiloxy units, diphenylsiloxy units and phenylmethylsiloxy units, among others. The molecular structure is also not critical and is exemplified by straight-chain and partially branched straight-chain structures, the linear systems being the most typical.

In the addition cure embodiment of the present invention, compound (b′) is added and is an organohydrido silicon compound (b′), that crosslinks with the curable organopolysiloxane (a′). The organohydrido silicon compound is an organopolysiloxane which contains at least 2 silicon-bonded hydrogen atoms in each molecule which are reacted with the alkenyl functionality of (a′) during the curing of the composition. Those skilled in the art will, of course, appreciate that component (b′) must have a functionality greater than 2 to cure the curable organopolysiloxane. The position of the silicon-bonded hydrogen in component (b′) is not critical, and it may be bonded at the molecular chain terminals, in non-terminal positions along the molecular chain or at both positions. The silicon-bonded organic groups of component (b′) are independently selected from any of the saturated hydrocarbon or halogenated hydrocarbon groups described above in connection with curable organopolysiloxane (a′), including preferred embodiments thereof. The molecular structure of component (b′) is also not critical and is exemplified by straight-chain, partially branched straight-chain, branched, cyclic and network structures, linear polymers or copolymers being typical.

Typical organohydrido silicon compounds are polymers or copolymers comprising RHSiO_{2/2} units terminated with either R₃SiO_{1/2} or HR₂SiO_{1/2} units wherein R is independently selected from alkyl groups having 1 to 20 carbon atoms, phenyl or trifluoropropyl, typically methyl. Also, typically the viscosity of component (b′) is 0.5 to 1,000 mPa·s at 25° C., alternatively 2 to 500 mPa·s. Component (b′) typically has 0.5 to 1.7 weight percent hydrogen bonded to silicon. Alternatively, component (b′) is selected from a polymer consisting essentially of methylhydridosiloxane units or a copolymer consisting essentially of dimethylsiloxane units and methylhydridosiloxane units, having 0.5 to 1.7 weight percent hydrogen bonded to silicon and having a viscosity of 2 to 500 mPa·s at 25° C. Such a typical system has terminal groups selected from trimethylsiloxy or dimethylhydridosiloxy groups. Component (b′) may also be a combination of two or more of the above described systems.

The organohydrido silicon compound (b′) is used at a level sufficient to cure organopolysiloxane (a′) in the presence of component (c′), described infra. Typically, its content is adjusted such that the molar ratio of SiH therein to Si-alkenyl in (a′) is greater than 1. Typically, this SiH/alkenyl ratio is below 50, alternatively 1 to 20 or alternatively 1 to 12. These SiH-functional materials are well known in the art and many are commercially available.

In the addition cure embodiment of the present invention, component (c′) is a hydrosilylation catalyst that accelerates the cure of the organopolysiloxane (a′) and organohydrido silicon compound (b′). It is exemplified by platinum catalysts, such as platinum black, platinum supported on silica, platinum supported on carbon, chloroplatinic acid, alcohol solutions of chloroplatinic acid, platinum/olefin complexes, platinum/alkenylsiloxane complexes, platinum/beta-diketone complexes, platinum/phosphine complexes and the like; rhodium catalysts, such as rhodium chloride and rhodium chloride/di(n-butyl)sulfide complex and the like; and palladium catalysts, such as palladium on carbon, palladium chloride and the like. Component (c′) is typically a platinum-based catalyst such as chloroplatinic acid; platinum dichloride; platinum tetrachloride; a platinum complex catalyst produced by reacting chloroplatinic acid and divinyltetramethyldisiloxane which is diluted with dimethylvinylsiloxy endblocked polydimethylsiloxane, prepared according to U.S. Pat. No. 3,419,593 to Willing; and a neutralized complex of platinous chloride and divinyltetramethyldisiloxane, prepared according to U.S. Pat. No. 5,175,325 to Brown et al. Alternatively, catalyst (c′) is a neutralized complex of platinous chloride and divinyltetramethyldisiloxane.

Component (c′) is added to the present composition in a catalytic quantity sufficient to promote the reaction between curable organopolysiloxane (a′) and component (b′) so as to cure the organopolysiloxane. Typically, the hydrosilylation catalyst is added so as to provide 0.1 to 500 parts per million (ppm) of metal atoms based on the total weight of the silicone component, alternatively 0.25 to 50 ppm.

In another embodiment, components (a), (b), and (c) are selected to provide a condensation cure of the organopolysiloxane. For condensation cure, an organopolysiloxane having at least 2 silicon bonded hydroxy groups (i.e. silanol, considered as the curable groups) would be selected as component (a), a organohydrido silicon compound would be selected as the optional crosslinking agent (b), and a condensation cure catalyst known in the art, such as a tin catalyst, would be selected as component (c). The organopolysiloxane useful as a condensation curable organopolysiloxane is any organopolysiloxane which contains at least 2 hydroxy groups (or silanol groups) in its molecule. Typically, any of the organopolysiloxanes described supra as component (a′), can be used as the organopolysiloxane in the condensation cure embodiment, although the alkenyl group would not be necessary in this embodiment. The organohydrido silicon compound useful as the optional crosslinking agent is the same as described infra for component (b′). The condensation catalyst useful as the curing agent in this embodiment is any compound which will promote the condensation reaction between the SiOH groups of organopolysiloxane (a′) and the SiH groups of organohydrido silicon compound (b′) so as to cure the former by the formation of —Si—O—Si— bonds. Examples of suitable catalysts include metal carboxylates, such as dibutyltin diacetate, dibutyltin dilaurate, tin tripropyl acetate, stannous octoate, stannous oxalate, stannous naphthanate; amines, such as triethyl amine, ethylenetriamine; and quaternary ammonium compounds, such as benzyltrimethylammoniumhydroxide, beta-hydroxyethylltrimethylammonium-2-ethylhexoate and beta-hydroxyethylbenzyltrimethyldimethylammoniumbutoxide (see, e.g., U.S. Pat. No. 3,024,210).

Component (A) can also be a pre-cured silicone emulsion. In this embodiment, the silicone component is cured prior to being emulsified to form the aqueous silicone emulsion. Aqueous emulsions of pre-cured silicones are well known in the art and are expected to be suitable as component (A) in the present invention. Typically, such emulsions are formed by emulsifying organopolysiloxanes, which have been cured by the either addition or condensation techniques, as described supra, and subsequently emulsified using suitable emulsifying agents. Representative, non-limiting examples of pre-cured silicone emulsions useful as component (A) in the present invention are described in U.S. Pat. Nos. 5,674,937 and 5,994,459.

Component (A) can also be a pre-cured silicone emulsion that is derived from a process that the curing of silicone composition occurs after the emulsion is formed. In this case, the silicone composition within the emulsion may be a silicone compound containing self-curable functional groups or a mixture of silicone compounds containing hydrosilylation reactive groups.

Component (B) of the compositions of the present invention is a polyurethane dispersion. “Polyurethane dispersion” as used herein describes mixtures of polyurethane polymers in water. Methods of preparing polyurethane dispersions are well known in the art and many polyurethane dispersions are commercially available. Polyurethane polymers are generally characterized by their monomer content and most commonly involve the reaction of a diisocyanate with a polyol and chain extender. While the present inventors believe the polyurethane dispersion can be an aqueous mixture of any known polyurethane, typically the polyurethanes suitable for the use in the aqueous polyurethane dispersions are the reaction products (a) an isocyanate compound having at least two isocyanate (—NCO) functionalities per molecule; (b) a polyol having at least two hydroxy functionalities per molecule and a molecular weight ranging from 250 to 10,000 g/mol. The polyol may be selected from those commonly found in polyurethane manufacturing such as hydroxy-containing or terminated polyethers, polyesters, polycarbonates, polycaprolactones, polythioethers, polyetheresters, polyolefins, and polydienes. Suitable polyether polyols for the preparation of polyether polyurethanes and their dispersions include the polymerization products of cyclic oxides such as ethylene oxide, propylene oxide, tetrahydrofuran, or mixtures thereof. Polyether polyols commonly found include polyoxyethylene (PEO) polyols, plyoxypropylene (PPO) polyols, polyoxytetramethylene (PTMO) polyols, and polyols derived from the mixture of cyclic oxides such as poly(oxyethylene-co-polypropylene) polyols. Typical molecular weights of polyether polyols can range from 250 to 10,000 g/mol. Suitable polyester polyols for the preparation of polyester polyurethanes and their aqueous dispersions include; hydroxy-terminated or containing reaction products of ethylene glycol, propylene glycol, diethylene glycol, neopentyl glycol, 1-4, butanediol, furan dimethanol, polyether diols, or mixtures thereof, with dicarboxylic acids or their ester-forming derivatives.

Modified polyether polyurethanes such as polyetherester polyurethanes and polyethercarbonate polyurethanes may also be suitable polyurethanes for the preparation of aqueous polyurethane dispersions. These modified polyether polyurethanes can be derived by incorporating additional polyester polyols or polycarbonate polyols into polyether polyols during the polyurethane manufacturing.

Typically the polyurethane polymer useful to prepare the polyurethane dispersion as component (B) in the compositions of the present invention is selected from polyether polyurethanes, polyester polyurethanes, polycarbonate polyurethanes, polyetherester polyurethanes, polyethercarbonate polyurethanes, polycaprolactone polyurethanes, hydrocarbon polyurethanes, aliphatic polyurethanes, aromatic polyurethanes, and combinations thereof.

“Polyurethane dispersion” as used herein encompasses both conventional emulsions of polyurethane polymers, for example where a preformed polyurethane polymer is emulsified into an aqueous medium with the addition of surfactants and application of shear, and also includes stable mixtures of self-dispersing polyurethane polymers. Polyurethane dispersions of self-dispersing polyurethane polymers are well known in the art and many are commercially available. These polyurethane dispersions are generally free of external surfactants because chemical moieties having surfactant like characteristics have been incorporated into the polyurethane polymer and therefore are “self emulsifying” or “self dispersing”. Representative examples of internal emulsifier moieties that can be incorporated into the polyurethane dispersions useful in the present invention include; ionic groups such as sulfontates, carboxylates, and quaternary amines; as well as nonionic emulsifier groups such as polyethers. Such polyurethane dispersions are well known in the art, and are typically prepared by either a one stage or two-stage process. Typically, an isocyanate-terminated polyurethane prepolymer is made from isocyanates, polyols, optional chain extender, and at least one monomer containing a hydrophilic group to render the pre-polymer water dispersible. The polyurethane dispersion can then be prepared by dispersing the isocyanate-terminated polyurethane pre-polymer in water with other polyisocyanates. Further chain extension can be effected by the addition of chain extenders to the aqueous dispersion. Depending on the choice of the hydrophilic group used to render the polyurethane polymer water dispersible, an additional reaction step may be needed to convert the hydrophilic group to an ionic species, for example converting a carboxyl group to an ionic salt or an amine to an amine salt or cationic quaternary group.

Representative, non-limiting examples of polyurethane dispersions that are suitable for use as component (B) in the compositions of the present invention, as well as general descriptions of techniques useful to prepare polyurethane dispersions can be found in U.S. Pat. Nos. 4,829,122, 4,921,842, 5,025,064, 5,055,516, 5,308,914, 5,334,690, 5,342,915, 5,717,024, 5,733,967, 6,017,998, 6,077,611, 6,147,155, and 6,239,213.

Representative, non-limiting examples of commercially available polyurethane dispersions that are suitable for use as component (B) in the compositions of the present invention include: WITCOBOND W 290H, W 296, and W 213 (Uniroyal Chemical Division, Crompton Corporation, Middlebury, Conn.); DISPERCOLL U42, BAYHYDROL 121, and Bayhydrol 123 polycarbonate polyurethane dispersions (100 Bayer Road, Pittsburgh, Pa. 15025); SANCURE 2710 and 2715 aliphatic polyether polyurethane dispersions (Noveon, Inc. Cleveland, Ohio); NEOREZ R-966, R-967, R-9603 aliphatic polyurethane dispersions (NeoResins Division, Avecia, Wilmington, Mass.).

Optionally, an adhesion promoter, component (C), can be added to the reaction product of (A) and (B) to form the coating compositions of the present invention. Generally, the adhesion promoter can be selected from organofunctional silanes known in the art to enhance the adhesion of polymeric films to various surfaces. Often, these organofunctional silanes are referred to as silane coupling agents in the art. Typical of the organofunctional silanes that can be added to the curable compositions of this invention are those described in U.S. Pat. No. 6,042,943. Typically, the organofunctional silane is selected from 3-(trimethoxysilyl)propyl acrylate, methacryloxypropyltrimethoxysilane, tetraethoxysilane, allyltrimethoxysilane, vinyltrimethoxysilane, vinyltriethoxysilane, octyltriethoxysilane, methyltriethoxysilane, methyltrimethoxysilane, vinylmethyldimethoxysilane, β-(3,4-epoxycyclohexyl)ethyltrimethoxysilane, and γ-glycidylpropyltrimethoxysilane. Alternatively, the organofunctional silane is β-glycidylpropyltrimethoxysilane such as Z-6040 (Dow Corning Corporation, Midland, Mich.).

The amount of adhesion promoter added to the composition can vary, but generally is 0.05 to 10.0 weight percent of the total coating composition. Alternatively, the adhesion promoter is 0.1 to 5 weight percent of the total coating composition.

Alternatively, the airbag fabric can be treated with an adhesion promoter, as defined infra, prior to coating with the compositions of the present invention. When used in this manner, a coat weight of less than 10 g/m² is typically sufficient to ensure adhesion of the cured coatings to the airbag fabric.

Other additives can be optionally incorporated into the coating composition of this invention, as component (D), to derive additional specific features. Such additives include, but not limited to; reinforcing or extending fillers such as colloidal silica, fumed silica; colorants and pigments; stabilizers as thermal, UV, and weathering stabilizers; flame retardants, thickeners, biocides, and preservatives.

The curable coating compositions can be prepared by mixing components (A), (B), and optionally (C) and (D) by any of the techniques known in the art such as milling, blending, and stirring, either in a batch or continuous process. The viscosity of the components and final curable coating composition typically determines the technique and particular device selected. Representative examples of batch reactors that can be used to prepare the curable coating compositions include batch mixers readily available from the following suppliers; Ross, Myers, Turello, Premier, Hockmeyer, and Spangenberg.

The present invention also provides a method of coating a fabric comprising;

(I) applying a composition on one surface of the fabric, the composition comprising;

A) 5 to 60 weight parts of a silicone component wherein the silicone component is derived from an aqueous silicone emulsion, and
B) 40 to 95 weight parts of a polyurethane component wherein the polyurethane component is derived from an aqueous polyurethane dispersion, and
   (II) exposing the layer to air for sufficient time to form a cured coating.

The components A) and B) in this method, are the same as described above and techniques for applying these components to fabrics are further described below.

Step (II) of the method of the present invention is exposing the layer of the composition on the fabric to air for sufficient time to form a cured coating. Step (II) can be accelerated by increasing the temperature at which this step is performed, for example, from about room temperature to about 180° C., alternatively from room temperature to about 150° C., or alternatively from about room temperature to about 130° C., and allowing the coating to cure for a suitable length of time.

The coating compositions may be applied to fabric substrates according to known techniques. The compositions can be applied a various coat weights, but typical coat weights are 30-35 g/m². Coating techniques include, but not limited to, knife coating, roll coating, dip coating, flow coating, squeeze coating, and spray coating. Knife coating includes knife-over-air, knife-over-roll, knife-over-foam, and knife-over-gap table methods. Roll coating includes single-roll, double-roll, multi-roll, reverse roll, gravure roll, transfer-roll coating methods.

The coating composition can be cured by exposing the composition to air for sufficient time to allow the coating to cure. The cure step can be accelerated by increasing the temperature, for example, from about room temperature to about 180° C., alternatively from room temperature to about 150° C., or alternatively from about room temperature to about 130° C., and allowing the coating to cure for a suitable length of time. For example, the coating composition typically cures in less than about 3 min at 150° C.

The coating compositions of the present invention have excellent film forming properties and adhere well to a variety of substrates such as fabrics, fibers, yarns, and textiles. Thus, the coatings of the present invention can be applied to a variety of fabrics, fibers, yarns, and textiles.

The coating composition can be applied on wet or dry air bag fabric. These water based emulsion airbag coatings can be applied directly onto any fabric that is useful to construct an airbag article such as woven fabrics for airbags, pre-sewn airbags roll substrates, or one-piece-woven (OPW) airbag fabrics. Fabrics and airbags prepared from other fibers can also be applied with Si/PU coatings that is disclosed in this invention to arrive at similar reduction in air permeation. Example fibers include, but not limited to, polyesters such as polyethylene terephthalate (PET), polybutylene terephthalate (PBT), and derivatives containing them, polyamide fibers, polyetheresters, polyester amide copolymers, and polyether amide copolymers.

The coating compositions of the present invention can also be applied to wet fabrics, immediately following a scouring operation. The compositions provide good adhesion to the fabric surface, and dries to a uniform coating without imperfections.

The coating composition of the instant invention produces coatings that are useful as fabric coatings, and in particular for decreasing air permeability of the coated fabrics at relatively lower coating weights. Thus, the coating compositions of the present invention provide coated fabrics suitable for the construction of automotive airbag articles with improved air/gas retention properties.

### EXAMPLES

The following examples are presented to further illustrate the compositions and methods of this invention, but are not to be construed as limiting the invention, which is delineated in the appended claims. All parts and percentages in the Examples are on a weight basis and all measurements were obtained at about 23° C., unless indicated to the contrary.

The particle size and profile of the formed emulsion coating compositions were evaluated using a MALVERN MASTERSIZER S (Malvern Instruments, Malvern, UK) equipped with 300RF mm range lens to detect particle size in the range 0.05 to 900 μm. The particle size profile indicates the stability and compatibility of mixture emulsion coatings. The particle size profile of an emulsion coating is reported using these three parameters: D(v, 0.5), D(v, 0.9) and span. D(v, 0.5) is referred as the average particle size and is the size of particle at which 50% of the sample is smaller and 50% is larger than this size. This value is also known as the mass medium diameter. D(v, 0.9) gives a size of particle for which 90% of the sample is below this size. Span is the measurement of the width of the particle size distribution and is the ratio of [D(v, 0.9)-D(v, 0.10)] to D(v, 0.5).

The effectiveness of the compositions representative of this invention as coatings for airbag applications were evaluated via an air deployment test using T-shaped airbags woven from Nylon 6,6 polyamide multi-filament yarns. The T-shaped airbags (or T-bag in short) were produced from woven fabrics using one-piece woven (OPW) technology with 470 dtex (or 235 g/m²) woven specification and had a surface area of 0.0454 to 0.04796 m² per side. The coatings were applied onto the airbag fabrics using the knife-over-air method on a Werner Mathis U.S.A. lab-coater (Concord, N.C.). The coated airbags were flash dried for 1 minute at 100° C., followed by curing for 3 minutes at 130° C. The coated T-bags were then evaluated for air deployment and rentention using a lab testing unit. The deployment testing involved mounting the T-bag onto the testing device through the openings of the bags. A pressurized canistor with a predetermined amount of air was then “bombed” (i.e. quickly released) into the T-bag such that the initial peak pressure reached 3.5 bar (350 kPa) inside the T-bag. The air pressure inside the T-bag was constantly monitored and graphed as a function of time. The time required to deflate down to 0.5 bar (50 kPa) of pressure was reported as the T-bag deployment hold-up time.

### Examples 1-3

Comparative Examples of Silicone Coated Airbag Performance

To illustrate the air retention property of the coatings of the present invention, a series of air bag coating compositions were prepared from representative commercial products presently used in the airbag coating industry. DC 3730 (Dow Corning Corporation, Midland, Mich.) liquid silicone rubber (LSR) was selected for this comparison. DC 3730 is supplied as two-part silicones (A and B parts) comprising of vinyl-functional silicone fluids, hydride-functional fluids, platinum catalyst, silica filler and others. The LSR thermally cured to form a cross-linked silicone coating matrix. The resulting mechanical properties are summarized in Table 1.

TABLE 1

| | Patent example | | |
|---|---|---|---|
| | 1 | 2 | 3 |
| Coating type | DC 3730 LSR | DC 3730 LSR | DC 3730 LSR |
| Coat wt., g/m² | 35 | 70 | 130 |
| T-bag deployment | 0.65 | 4.23 | 24.5 |
| hold-up, initial | | | |
| (seconds) | | | |
| T-bag deployment | <0.2 | 2.66 | 6.56 |
| hold-up, after aged | | | |
| 400 hrs @ 107° C. | | | |
| (seconds) | | | |

As shown in these examples, to achieve a T-bag deployment hold-up time of 5 seconds or higher, a coat weight of over 100 g/m² over Nylon 6,6 airbag was required. Additionally, the LSR coated airbags have relatively poor thermal aging stability, as illustrated in Examples 1 to 3.

### Examples 4-6

Reference Examples; Preparation of Curable LSR Silicone Emulsions

Curable silicone emulsions were prepared for use as representative examples of the silicone emulsions that can be used in the preparation of the coating compositions of the present invention. The formulations for these silicone emulsions are shown in Table 2. The silicone components used in these emulsions comprised: a) three different vinyl functional organopolysiloxanes, designated as Vi Siloxane 1, 2, and 3; and b) a poly(dimethyl-co-methylhydrogen)siloxane containing 0.76% hydrogen and having a viscosity of 5 cSt (0.05 cm²/s), as the organohydrio silicon compound. Vi Siloxane 1 was a dimethylvinyl siloxy terminated dimethylpolysiloxane having a viscosity of 55,000 cP (55,000 mPa·s), designed as M^{Vi}DₓM^{Vi} in Table 2. Vi Siloxane 2 was a dimethylvinyl siloxy terminated, dimethyl polysiloxane having a viscosity of 450 cP (450 mPa·s), designed as M^{Vi}DₓM^{Vi} in Table 2. Vi Siloxane 3 was a dimethylvinyl siloxy terminated, dimethyl, methylvinyl polysiloxane having a viscosity of 350 cP (350 mPa·s), designed as M^{Vi}DₓD^{Vi}_{y}M^{Vi} in Table 2. These silicone mixtures were emulsified using either selected partially hydrolyzed polyvinylacetate or polyvinyl alcohol (PVA solution prepared from Mowinol 30-92 of Clariant: a 92% hydrolyzed PVA with a viscosity of 30 cSt for a 4 wt. % aqueous solution), or polyoxyethylene lauryl either (Brij 30, Brij 35L). These emulsions were prepared in a high shear Hauschild mixer by gradually incorporating deionized water to form an emulsion of curable silicones. The particle size profile of these emulsions varied, depending on the type of surfactants used, as summarized in Table 2.

TABLE 2

| | | Patent examples | | |
|---|---|---|---|---|
| | | 4 | 5 | 6 |
| Vi Siloxane 1 | M^{Vi}DxM^{Vi} | 17.18 | 17.18 | 17.18 |
| Vi Siloxane 2 | M^{Vi}DxM^{Vi} | 3.23 | 3.23 | 3.23 |
| Vi Siloxane 3 | M^{vi}DxD^{vi}yM^{vi} | 2.62 | 2.62 | 2.62 |
| SiH Siloxane | MD^{H}xDyM | 1.69 | 1.69 | 1.69 |
| Surfynol 61 | Inhibitor | 0.26 | 0.26 | 0.26 |
| PVA Sol 80 TAD | 20% Mowinol 30-92 | | | 2.4 |
| | (Clariant) | | | |
| 4-98 PVA solution | 10% Mowinol 4-98 | | | |
| (20%) | | | | |
| 5-88 PVA solution | 10% Mowinol 5-88 | | | |
| (10%) | | | | |
| Brij 35L | polyoxyethylene | 2 | 1.2 | |
| | (23) lauryl ether | | | |
| Brij 30 | polyoxyethylene | | 0.5 | |
| | (4) lauryl ether | | | |
| D.I. Water | | 10 | 6 | 9.7 |
| Total parts | | 36.98 | 32.68 | 37.08 |
| Wt. % solids | | 71.3 | 80.5 | 68.7 |
| pH reading | | 4.1 | 4.5 | 5.4 |
| Emulsion | | white | white | white |
| appearance | | creamy | creamy | creamy |
| Particle size * | | 0.613 | 1.695 | 5.672 |
| D(v, 0.5) | | | | |
| D(v, 0.9), | | 1.01 | 3.69 | 14.69 |
| span | | 1.12 | 1.74 | 2.55 |

* Particle size reported in micrometers

### Examples 7-9

Coatings Prepared From Addition Curable Liquid Silicone Rubber Emulsions

Waterborne coatings were prepared from the addition curable liquid silicone rubber (LSR) emulsions of reference examples 4 and 5 and several commercially available polyurethane dispersions, as summarized in Table 3. The polyurethane dispersions used were Sancure 2715 polyurethane dispersion (from Noveon Inc., Cleveland, Ohio), and Dispercoll U42 polyurethane dispersion (Bayer, Pittsburgh, Pa.). Witcobond XW epoxy emulsion was also added as an adhesion promoter. Nalco 1050 colloidal silica was added as optional reinforcing filler. Syl-Off 7927 platinum emulsion catalyst was incorporated to cure the silicone polymers within the silicone emulsion upon heating and drying. Polacryl BR-300 was added as a thickener to control the viscosity of the coating and to improve the coating application and quality.

The Si/PU coatings were prepared by incorporating silicone emulsion components gradually into PU dispersion, followed by mechanical stirring to yield a homogeneous mixture is yield. This is done to ensure minimal pH shock to the PU dispersion(s), as many of the silicone emulsions are acidic in nature. In some case, the pH of the mixture is monitored to ensure the pH of the Si/PU mixture stayed above 6.0. Optional curing agent, adhesion promoter, and additives were added subsequently. If necessary, a buffer solution could be used to keep the final Si/PU emulsion mixture at a pH 6.0 or higher. The particle size profile is taken on the final Si/PU coating mixture. An average particle size, D(v, 0.5), of sub-micron is a good indication of successful preparation of Si/PU coating mixtures.

The resulting Si/PU coatings were all homogeneous, and stable emulsions. To illustrate the excellent film-forming property and the mechanical property, cured films were made by casting onto a Teflon mode and dried. The resulted films were uniform with milky appearance and have characteristic strength of a tough elastomers; i.e. high tensile strength.

TABLE 3

| | Patent examples | | |
|---|---|---|---|
| | 7 | 8 | 9 |
| Si emulstion type | Add. Cure | Add. Cure | Add. Cure |
| Si/PU ratio | 40/60 | 40/60 | 40/60 |
| Colloidal silica, | | | |
| wt. % | | | |
| Crosslinker, | | | |
| wt. % (total) | | | |
| Crosslinker, | | | |
| wt. % (PU) | | | |
| Sancure 2715 PUD | 40 | 26.3 | 40 |
| Dispercoll U42 PUD | | 10 | |
| Witcobond XW | 1 | 1 | 1 |
| Nalco 1050 | 4.5 | 4.5 | 4.5 |
| Silicone emulsion | 16 | 16 | |
| of example 4 | | | |
| Silicone emulsion | | | 16 |
| of example 5 | | | |
| Syl-Off 7927 Pt | 1.8 | 1.8 | 1.8 |
| catalyst | | | |
| Polacryl BR-300 | 0.4 | 0.4 | 0.4 |
| Total parts | 63.7 | 60 | 63.7 |
| Malvern, particle | | | |
| size* D(v, 0.5) | | | |
| D(v, 0.9) | 38.8 | 38.8 | 38.8 |
| Span | 8.829 | 8.829 | 8.829 |
| Wt. % soids | 44.6 | 44.6 | 44.6 |
| T-bag deployment; | | | |
| hold-up time in | | | |
| seconds | | | |
| Coat wt. on T-bag | | | |
| Cured coatings | 1937 (13.3) | 1532 (10.5) | 2391 (16.5) |
| tensile, psi (MPa) | | | |
| % Elongation | 200 | 212 | 236 |
| Modulus at 100%, | 1287 (8.9) | 903 (6.2) | 1385 (9.5) |
| psi (MPa) | | | |

*particle size reported in micrometers

### Examples 10-12

Coatings Based on Addition-Curable Silicone Emulsions

Coating compositions were also prepared from commercially available addition-curable silicone emulsions, as summarized in Table 4. Examples 10-12 illustrate the deployment hold-up times for airbags coated with these coatings. The waterborne Si/PU coatings were applied, using conventional knife-over-air technique, onto a one-piece-woven (OPW) Nylon6,6 airbag fabrics. The coated airbags were dried and cured at 130° C. for 2 mintues to give a cured coating weight of about 30 g/m². The coated airbags were tested for their air hold-up property using a custom-built deployment test device. The coated T-shaped airbags were mounted to a compressed air canistor with a prescribed amount of air. The compressed air was released into the coated airbag on depolyment to reach a burst pressure of about 3.5 bar (i.e. 350 kPa). The air hold-up time of the coated airbag is the time it elapsed when the air pressure inside the airbag reached 0.5 bar (i.e. 50 kPa). For uncoated airbag, the compressed air leaked through the airbag too fast to report a time. For a typical 3730 LSR coated airbag at about 35 g/m², the time was less than 1 second.

The Si/PU aqueous coatings exhibited excellent film integrity and air-retention property, even at a low coat weight of about 30 g/m², as summarized in Table 4.

TABLE 4

| | Patent examples | | |
|---|---|---|---|
| | 10 | 11 | 12 |
| Si/PU ratio | 40/60 | 40/60 | 30/70 |
| Si emulsion type | Add. Cure | Add. Cure | Add. Cure |
| Sancure 2715 PUD | 40 | 26.3 | 30.7 |
| Dispercoll U42 PUD | | 10 | |
| Syl-Off 7910 | 25 | 25 | 12.5 |
| Syl-Off 7927 | 0.87 | 0.87 | 0.43 |
| BR-300 thickener | 0.8 | 0.8 | 0.8 |
| Total parts | 66.67 | 62.97 | 44.43 |
| Wt. % solids | 38.8 | 40.9 | 38.5 |
| pH @ 25° C. | 8.829 | 8.667 | |
| Particle size*, | 0.466 | 0.318 | 0.463 |
| D(v, 0.5) | | | |
| D(v, 0.9) | 1.27 | 0.86 | 1.43 |
| Span | 2.44 | 2.38 | 2.82 |
| T-bag deployment; | 8.3 | 16.35 | 22.35 |
| hold-up time | | | |
| in seconds | | | |
| Coat wt. on | 29.8 | 29.8 | 31.4 |
| T-bag, g/m2 | | | |
| Cured coating, | 2544 (17.5) | 2161 (14.9) | 2875 (19.8) |
| tensile, psi (MPa) | | | |
| % Elongation | 394 | 359 | 382 |
| Modulus at 100%, | 1022 (7.0) | 675 (4.6) | 1040 (7.2) |
| psi (MPa) | | | |

*particle size reported in micrometers

### Examples 13-14

Coatings Derived From Pre-Cured Silicone Elastomer Emulsion

Waterborne Si—PU coatings useful as fabric and airbag coatings were also prepared from emulsion latex of a pre-cured silicone elastomer. The silicone component used in the following example coatings was Dow Corning® 3-2345 silicone latex. The 3-2345 silicone latex is a 85 wt. % solids water-continuous emulsion of a silicone elastomer. The silicone elastomer in the oil phase is a reaction product of vinyl-functional silicone fluids and hydride-functional silicone fluids which are cured via a platinum catalyzed addition reaction. The polyurethane component was SANCURE 2715 polyurethane dispersion (Noveon Inc.) and DISPERCOLL U42 polyurethane dispersion (Bayer Corp.). The formulations and resulting physical properties are summarized in Table 5.

The Si—PU coatings based on these compositions displayed excellent air retention property at low coating weights, as summarized in Table 5.

TABLE 5

Patent examples

| | 13 | 14 |
|---|---|---|
| Si/PU ratio | 30/70 | 40/60 |
| Si emulsion type | Pre-cured | Pre-cured |
| Sancure 2715 PUD | 30.7 | 26.3 |
| Dispercoll U42 PUD | | 10 |
| 3-2345 silicone latex | 11.2 | 11.2 |
| BR-300 thickener | 0.8 | 0.8 |
| Total parts | 42.7 | 48.3 |
| Viscosity, cps | | |
| Wt. % soids | 49.4 | 53 |
| pH @ 25° C. | | 9.63 |
| Malvern particle size*, | 1.167 | 0.322 |
| D(v, 0.5) | | |
| D(v, 0.9) | 2.53 | 1.25 |
| Span | 1.74 | 3.56 |
| T-bag deployment; | 8.5 | 13.2 |
| hold-up time in seconds | | |
| Coat wt. on T-bag, g/m2 | 28.6 | 28.98 |
| Cured coating, tensile, psi (MPa) | 1800 (12.4) | — |
| % Elongation | 395 | — |
| Modulus at 100%, psi (MPa) | 687 (4.7) | — |

### Examples 15-19

Curable Si/PU Coatings Derived From Selected Polyurethane Dispersions

The fabrics and airbags coated with Si/PU coatings in this invention also have very desirable surface property: low coefficient of friction, smooth silky feel of a silicone, and tack-free surface. Illustrated in the following examples are the selected Si/PU coatings prepared from addition curable silicone emulsion (Syl-Off 7910 emulsion silicone fluids and Syl-Off 7927 emulsion platinum catalyst). The polyurethane silicone components are selected from Sancure 2715 (anionic polyurethane dispersion at 38 wt. % solids, from Noveon Inc.), UCX-021-005 (anionic polyurethane dispersion at 50.9% solids, from Uniroyal Chemical, Crompton Corp.), and Dispercoll U42 (anionic polyurethane dispersion at 51% solids, Bayer Corp.).

To illustrate the desirable surface property of the Si/PU coatings, two separate sets of comparative examples were also included: a pure silicone coating (Example 17), and a polyurethane coating (Examples 18 and 19). These coatings were applied onto Nylon 6.6 woven fabric and cured to give coated fabrics. The coefficient of friction of the coated fabrics was measured. Table 6 summarizes the results for the Si/PU coated fabrics having a low coefficient of friction, smooth silky feel, and tack-free surface.

TABLE 6

| | Patent example | | | | |
|---|---|---|---|---|---|
| | 15 | 16 | 17 | 18 | 19 |
| Si/PU ratio | 40/60 | 40/60 | 100/0 | 0/100 | 0/100 |
| Si cure chem. | 7910 | 7910 | 7910 | 7910 | 7910 |
| Crosslinker, wt. % (total) | | 0 | | 0 | |
| Sancure 2715 PUD | 26.3 | | | | 26.3 |
| UCX-02-005 PUD | | 20 | | 20 | |
| Dispercoll U42 PUD | 10 | 10 | | 10 | 10 |
| Syl-Off 7910 | 25 | 25 | 25 | | |
| Syl-Off 7927 | 0.87 | 0.87 | 0.87 | | |
| BR-300 thickener | 0.5 | 0.5 | 0.5 | 0.5 | 0.5 |
| Total parts | 62.67 | 56.37 | 26.37 | 30.5 | 36.8 |
| Viscosity, cps | | | | | |
| Wt. % solids | 40.5 | 45.1 | 40 | 45.1 | 40.5 |
| Particle size * | 0.299 | | | | |
| D(v, 0.5) | | | | | |
| D(v, 0.9) | 0.96 | | | | |
| Span | 2.87 | | | | |
| T-bag deployment; | | | | | |
| hold-up time in seconds | | | | | |
| Coat wt. on T-bag | | | | | |
| Coat wt. on Flat fabric, g/m2 | 26 | 26 | 23 | 26 | 30 |
| CoF, static | 0.188 | 0.236 | 0.166 | 0.428 | 0.352 |
| CoF, kinetic | 0.109 | 0.186 | 0.129 | 0.398 | 0.235 |
| Cured film, tensile, psi (MPa) | 1861 (12.8) | 2205 (15.1) | | | |
| % Elongation | 409 | 350 | | | |
| Modulus at 100%, psi (MPa) | 529 (3.6) | 529 (3.6) | | | |

### Examples 20-24

Si/PU Coating Compositions with Selected Adhesion Promoter/Additives

Various Si—PU coatings were prepared from Sancure 13057 polyurethane dispersion, commercially obtained from Noveon, Inc. (Cleveland, Ohio), NeoRez 967 polyurethane dispersion (NeoResins, a division of Avecia, Wilmington, Mass.), 17545-129A curable silicone rubber emulsion (example 4 of this write-up), and Syl-Off 7927 platinum emulsion catalyst.

To this series of Si—PU coatings, the following adhesion promoters were respectively incorporated: Witcobond XW epoxy emulsion (from Uniroyal Chemical, Crompton Corp.), Z-6040 glycidoxypropyltrimethoxysilane (from Dow Corning Corp.), and Coat-O-Sil 1770 silane (Witco Corp., Crompton Corp.). These adhesion promoters were added at 2.2 wt. % of the total amount of the coating solids. Witcobond XW is an aqueous emulsion can be directly added to the coating; Z-6040 and CoatOsil 1770 silanes are added into the coating and become water dispersible after a short period of mixing and partial hydrolysis to form a water-soluble/compatible product. As shown in Table 7, coating quality was maintained, and the tensile strength and % elongation of the cured coatings were only moderately affected.

TABLE 7

| | Patent examples | | | | |
|---|---|---|---|---|---|
| | 20 | 21 | 22 | 23 | 24 |
| Si/PU ratio | 40/60 | 40/60 | 40/60 | 40/60 | 40/60 |
| Adhesion promoter, | 0 | 2.2 | 2.2 | 2.2 | 2.2 |
| wt. % | | | | | |
| Sancure 13057 PUD | 28.6 | 28.6 | 28.6 | 28.6 | 28.6 |
| NeoRez 967 PUD | 12.75 | 12.75 | 12.75 | 12.75 | 12.75 |
| Silicone emulsion | 16.7 | 16.7 | 16.7 | 16.7 | 16.7 |
| of example 4 | | | | | |
| Syl-Off 7927 | 0.87 | 0.87 | 0.87 | 0.87 | 0.87 |
| BR-300 thickener | 0.8 | 0.8 | 0.8 | 0.8 | 0.8 |
| Witcobond XW | | 1 | | | 0.5 |
| DC Z-6040 silane | | | 0.55 | | |
| CoatOsil 1770 silane | | | | 0.55 | 0.3 |
| Total parts | 59.72 | 60.72 | 60.27 | 60.27 | 60.52 |
| Wt. % solids | 43 | 43.2 | 43.5 | 43.5 | 43.4 |
| Coating quality | Good | Good | Good | Good | Good |
| Cured film, | 1949 | 2293 | 1686 | 2083 | 2377 |
| tensile, psi (MPa) | (13.4) | (15.8) | (11.6) | (14.3) | (16.4) |
| % Elongation | 428 | 395 | 269 | 362 | 412 |
| Modulus at 100%, | 479 | 529 | 639 | 547 | 554 |
| psi (MPa) | (3.3) | (3.6) | (4.4) | (3.7) | (3.8) |

1. A coated fabric comprising a fabric having a coating composition on at least a portion of the surface of the fabric, wherein the coating composition comprises a reaction product of;
A) 5 to 60 weight parts of a silicone component wherein the silicone component is derived from an aqueous silicone emulsion, and
B) 40 to 95 weight parts of a polyurethane component wherein the polyurethane component is derived from an aqueous polyurethane dispersion.

2. The coated fabric of claim 1 wherein the aqueous silicone emulsion is a curable silicone emulsion.

3. The coated fabric of claim 2 wherein the curable silicone emulsion comprises;
a) a curable organopolysiloxane,
b) an optional crosslinking agent,
c) a cure agent in an amount sufficient to cure said organopolysiloxane.

4. The coated fabric of claim 3 wherein the curable silicone emulsion is an addition curable silicone emulsion comprising;
(a′) a curable organopolysiloxane containing at least two alkenyl groups,
(b′) an organohydrido silicon compound,
(c′) a hydrosilylation catalyst.

5. The coated fabric of claim 2 wherein the aqueous silicone emulsion comprises an condensation curable organopolysiloxane.

6. The coated fabric of claim 1 wherein the aqueous silicone emulsion is a pre-cured silicone emulsion.

7. The coated fabric of claim 1 wherein the polyurethane dispersion comprises a polyurethane selected from polyether polyurethanes, polyester polyurethanes, polycarbonate polyurethanes, polyetherester polyurethanes, polyethercarbonate polyurethanes, polycaprolactone polyurethanes, hydrocarbon polyurethanes, aliphatic polyurethanes, aromatic polyurethanes, and combinations thereof.

8. The coated fabric of claim 1 further comprising;
(C) an adhesion promoter

9. The coated fabric of claim 8 wherein the adhesion promoter is an organofunctional silane.

10. The coated fabric of claim 9 wherein the organofunctional silane is selected from 3-(trimethoxysilyl)propyl acrylate, methacryloxypropyltrimethoxysilane, tetraethoxysilane, allyltrimethoxysilane, vinyltrimethoxysilane, vinyltriethoxysilane, octyltriethoxysilane, methyltriethoxysilane, methyltrimethoxysilane, vinylmethyldimethoxysilane, β-(3,4-epoxycyclohexyl)ethyltrimethoxysilane, and γ-glycidylpropyltrimethoxysilane.

11. The coated fabric of claim 1 further comprising;
(D) an additive selected from reinforcing fillers, extending fillers, colloidal silica, fumed silica, colorants, pigments, thermal stabilizers, UV stabilizers, weathering stabilizers, flame retardants, thickeners, biocides, and preservatives.

12. The coated fabric of claim 1 wherein the fabric is an airbag fabric.

13. The coated fabric of claim 1 wherein the fabric is a woven polyamide fabric.

14. An article of manufacture comprising the coated fabric of claim 1.

15. A method of coating a fabric comprising;
(I) applying a composition on one surface of the fabric, the composition comprising;
A) 5 to 60 weight parts of a silicone component wherein the silicone component is derived from an aqueous silicone emulsion, and
B) 40 to 95 weight parts of a polyurethane component wherein the polyurethane component is derived from an aqueous polyurethane dispersion, and
(II) exposing the layer to air for sufficient time to form a cured coating.

16. A coated fabric prepared by the method of claim 15.
